(19) United States
(12) Patent Application Publication
(10) Pub. No.: US 2025/0263031 A1
(43) Pub. Date: Aug. 21, 2025

(54) DOOR TRIM, VEHICLE DOOR, AND ROUTING STRUCTURE

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP); TOYOTA JIDOSHA KABUSHIKI KAISHA, Aichi (JP)

(72) Inventors: Yoshitaka IKEDA, Osaka (JP); Makoto HIGASHIKOZONO, Osaka (JP); Tsubasa MARUYAMA, Osaka (JP); Sho MURAKAMI, Osaka (JP); Makoto CHUJO, Osaka (JP); Hiroki SHUKURI, Aichi (JP); Itsuo WAKABAYASHI, Aichi (JP); Ikuyoshi OTAKE, Aichi (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP); TOYOTA JIDOSHA KABUSHIKI KAISHA, Aichi (JP)

(21) Appl. No.: 18/855,765

(22) PCT Filed: Apr. 11, 2023
(86) PCT No.: PCT/JP2023/014756

§ 371 Date: Oct. 10, 2024

(30) Foreign Application Priority Data
Apr. 18, 2022 (JP) 2022-068262

(51) Int. Cl. B60R 16/02; B60J 5/04; H02G 11/00

(52) U.S. Cl. CPC B60R 16/0222; B60J 5/0413; B60J 5/0418; H02G 11/00

(57) ABSTRACT

A door trim constitutes a design on an interior side of a vehicle door. The door trim includes a scheduled insertion region where a wire-like transmission member for an optional component mounted to the vehicle door is to be inserted.

### TECHNICAL FIELD

The present disclosure relates to a door trim, a vehicle door, and a routing structure.

### BACKGROUND ART

Patent Document 1 describes a technique of routing a door wire harness covered by a grommet closer to an exterior side than a weather-strip.

### PRIOR ART DOCUMENTS

### Patent Document(s)

Patent Document 1: Japanese Patent Application Laid-Open No. 2009-202727

### SUMMARY

### Problem to be Solved by the Invention

When considering routing of not only a wire harness for a standard-mounted component standardly mounted to a door but also a wire harness for an optional component added to a door afterward in a grommet, it is difficult to ensure a space for routing the wiring harness for the optional component in some cases. Furthermore, when the grommet is located closer to the exterior side than the weather-strip, it may be hard to route the wire harness for the optional component in the grommet due to a narrow operation space.

Accordingly, an object is to provide a technique capable of improving operability in routing a wire-like transmission member for an optional component.

### Means to Solve the Problem

A door trim according to the present disclosure is a door trim constituting a design on an interior side of a vehicle door, including a scheduled insertion region where a wire-like transmission member for an optional component mounted to the vehicle door is to be inserted.

### Effects of the Invention

According to the present disclosure, operability of routing a wire-like transmission member for an optional component is improved.

### BRIEF DESCRIPTION OF DRAWINGS

FIG. 1 is a schematic view illustrating an example of a door trim, a vehicle door, and a routing structure.

FIG. 2 is a schematic view illustrating an example of the door trim, the vehicle door, and the routing structure.

FIG. 3 is an enlarged schematic view illustrating an example of an area near a position into which a wire-like transmission member is inserted in an instrument panel and a door trim.

FIG. 4 is an enlarged schematic view illustrating an example of an area near the position into which the wire-like transmission member is inserted in the instrument panel and the door trim.

FIG. 5 is a schematic view illustrating an example that a cover member in a scheduled insertion region is detached.

FIG. 6 is a schematic view illustrating an example of a vehicle door.

FIG. 7 is a schematic view illustrating an example of the vehicle door.

FIG. 8 is an enlarged schematic view illustrating an example that a wire-like transmission member for an optional component is routed.

### DESCRIPTION OF EMBODIMENT(S)

### Description of Embodiments of Present Disclosure

Embodiments of the present disclosure are listed and described firstly.

A door trim, a vehicle door, and a routing structure according to the present disclosure is as follows.

(1) A door trim according to the present disclosure is a door trim constituting a design on an interior side of a vehicle door, including a scheduled insertion region where a wire-like transmission member for an optional component mounted to the vehicle door is to be inserted. According to the present disclosure, the door trim includes the scheduled insertion region where the wire-like transmission member for the optional component is to be inserted, thus the wire-like transmission member for the optional component can be routed independently from a wire-like transmission member for a standard-mounted component. Accordingly, operability of routing the wire-like transmission member for the optional component is improved.

(2) In the door trim according to (1), the scheduled insertion region may include: an insertion port into which the wire-like transmission member is inserted; and a cover member covering the insertion port. In this case, the wire-like transmission member for the optional component can be inserted into the preset insertion port, thus the wire-like transmission member can be easily routed.

(3) In the door trim according to (2), the insertion port may be a notched part reaching an edge of the door trim. In this case, the wire-like transmission member can be inserted into the insertion port from a side of the edge of the door trim. Accordingly, the wire-like transmission member can be easily inserted into the insertion port, and operability of routing the wire-like transmission member is improved.

(4) A vehicle door according to the present disclosure includes: the door trim according to any one of (1) to (3); a panel to which the door trim is attached; and a door-side weather-strip provided to the panel, wherein the scheduled insertion region is located closer to an interior side than the door-side weather-strip. According to the present disclosure, the scheduled insertion region is located closer to the interior side than the door-side weather-strip, thus water is hardly splashed on the wire-like transmission member for the optional component inserted into the scheduled insertion region.

(5) In the vehicle door according to (4), an arrangement space where a redundancy absorption part absorbing a redundant length of the wire-like transmission member occurring in accordance with a close operation of the vehicle door may be provided between the door trim and the panel. In this case, the redundancy absorption part disposed in the arrangement space can absorb the redundant length of the wire-like transmission member for the optional component occurring in accordance with the close operation of the vehicle door.

(6) In the vehicle door, a redundancy absorption part disposed in the arrangement space may be provided in the vehicle door according to (5). In this case, the redundancy length of the wire-like transmission member for the optional component occurring in accordance with the close operation of the vehicle door hardly interferes with opening and closing of the vehicle door.

(7) In the vehicle door according to (6), it is applicable that the redundancy absorption part includes: a winding shaft part around which the wire-like transmission member is wound; and a housing part housing a winding part around the winding shaft part in the wire-like transmission member, wherein a diameter of the winding part is changed in accordance with opening and closing of the vehicle door in the housing part. In this case, the redundant length of the wire-like transmission member for the optional component can be absorbed with a simple configuration that the diameter of the winding part around the winding shaft part is changed in accordance with opening and closing of the vehicle door in the wire-like transmission member for the optional component.

(8) In the vehicle door according to (6) or (7), it is applicable to provide a removal part removing water adhering to a part of the wire-like transmission member between the scheduled insertion region and the redundancy absorption part. In this case, water on the part of the wire-like transmission member led into the vehicle door in a close operation of the vehicle door can be removed. Thus, water is hardly splashed on an apparatus in the vehicle door.

(9) A routing structure according to the present disclosure includes: a first wire-like transmission member for an optional component mounted to the vehicle door to be routed between the vehicle door according to any one of (4) to (8) and a vehicle body to which the vehicle door is openably and closably attached and inserted into the scheduled insertion region of the door trim of the vehicle door; and a second wire-like transmission member for a standard-mounted component mounted to the vehicle door to be routed between the vehicle door and the vehicle body, wherein the vehicle door includes a door-side weather-strip provided to the panel, the vehicle body includes a vehicle body-side weather-strip, a part of the first wire-like transmission member between the vehicle door and the vehicle body is routed closer to an interior side than the door-side weather-strip and the vehicle body-side weather-strip, and a part of the second wire-like transmission member between the vehicle door and the vehicle body is routed closer to an exterior side than the door-side weather-strip and the vehicle body-side weather-strip. According to the present disclosure, differing from the second wire-like transmission member for the standard-mounted component, the first wire-like transmission member for the optional component is routed closer to the interior side than the door-side weather strip and the vehicle body-side weather strip, thus a space for an operation of routing the first wire-like transmission member for the optional component can be easily ensured.

(10) In the routing structure according to (9), the first wire-like transmission member may be inserted into a side surface part of an instrument panel of the vehicle body or routed between a frame of the vehicle body and the side surface part. In this case, the first wire-like transmission member can be hardly seen when the vehicle door is closed.

### Detailed Description of Embodiment of Present Disclosure

Specific examples of a door trim, a vehicle door, and a routing structure according to the present disclosure are described hereinafter with reference to the drawings. The present disclosure is not limited to these examples, but is indicated by claims, and it is intended that meanings equivalent to claims and all modifications within a scope of claims are included.

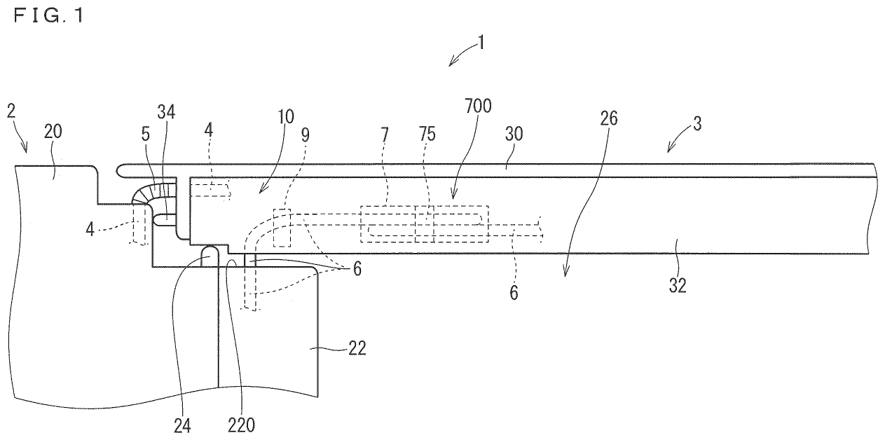

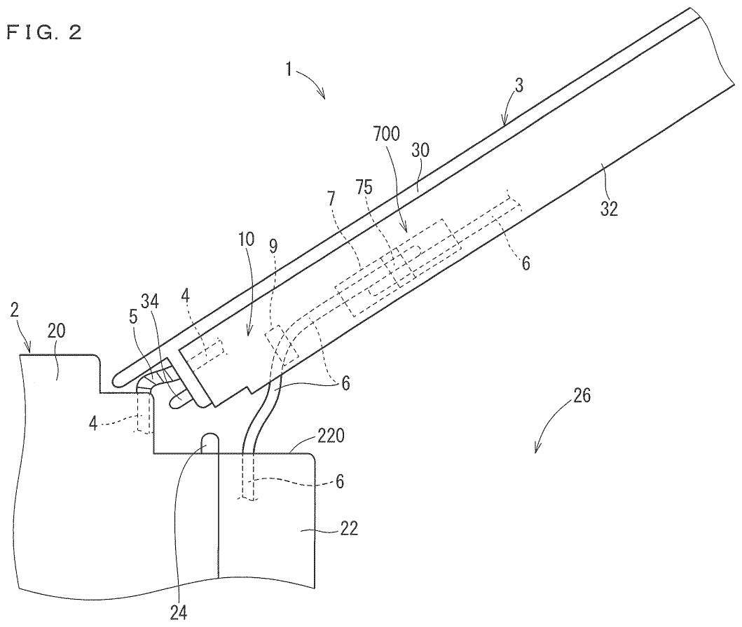

FIGS. 1 and 2 are schematic views illustrating an example of a vehicle 1. The vehicle 1 is an automobile, and includes a vehicle body 2, a vehicle door 3 (also simply referred to as the door 3) openably and closably attached to the vehicle body 2, and a routing structure 10 including a plurality of wire-like transmission members routed between the vehicle body 2 and the door 3. FIG. 1 illustrates an example of the closed door 3. FIG. 2 illustrates an example of the opened door 3.

Herein, the vehicle body 2 also includes an interior member such as an instrument panel 22 formed of resin in addition to a frame 20 formed of a metal member. The instrument panel 22 indicates not only a part covering an instrument, for example, but also includes an interior member (also referred to as a dashboard) around the part (in front of a front seat) herein. The instrument panel 22 includes an interior member ranging from a front side of a driver seat to a front side of a front passenger seat. The wire-like transmission member is a wire-like member transmitting electricity or light, for example. For example, the wire-like transmission member may be an electrical wire including a core wire and an insulating covering for covering the core wire. The wire-like transmission member may be a bare conductive wire, a shielded wire, a twisted wire, an enamel wire, a nichrome wire, or an optical fiber, for example. The wire-like transmission member transmitting the electricity may be various kinds of signal wires or various kinds of power wires. The wire-like transmission member may be a single wire-like object or a composite object of a plurality of wire-like objects (for example, a twisted wire and a cable made up of a plurality of wire-like objects covered by a sheath). The wire-like transmission member is also considered a wiring member.

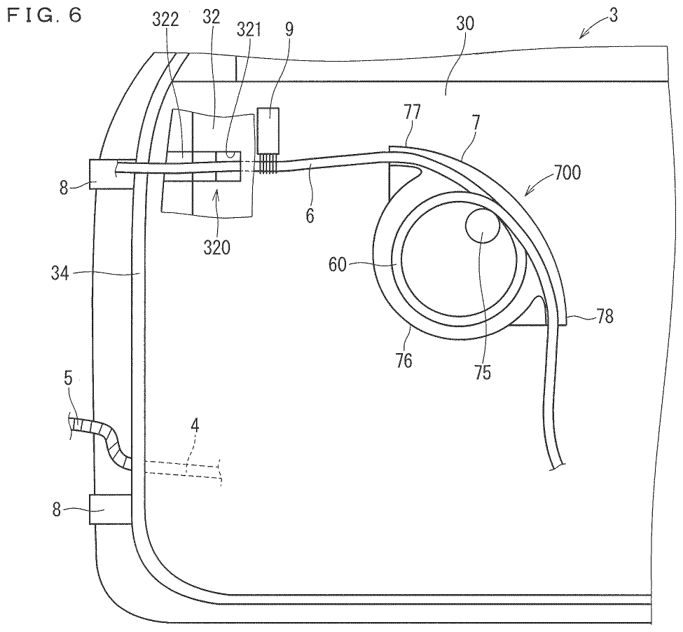

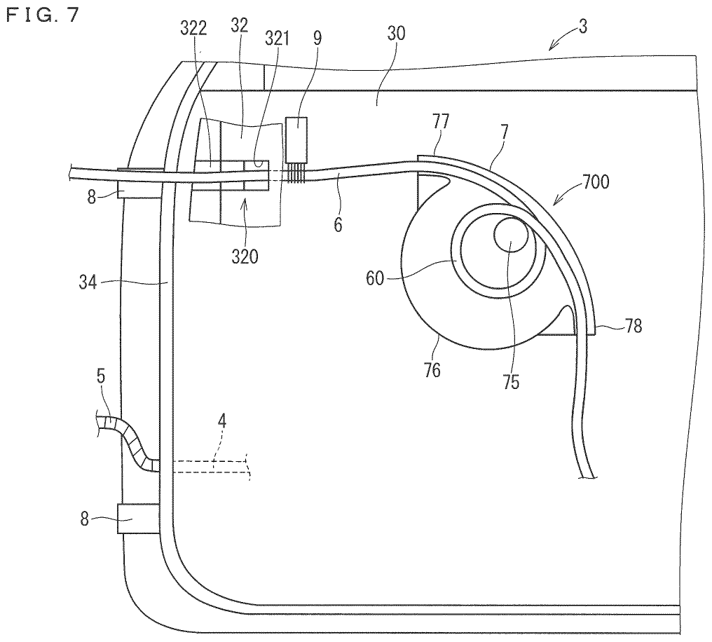

The door 3 is a front-side door, for example. The door 3 includes a metal panel 30 functioning as a frame of the door, a resin door trim 32 constituting a design on an interior side of the door 3, and a door-side weather-strip 34 for waterproof. The panel 30 includes an outer panel and an inner panel, for example. The door trim 32 is attached to the inner panel of the panel 30, for example. The door-side weather-strip 34 (also simply referred to as the weather-strip 34) is attached to the panel 30, and is located along an outer peripheral edge of the panel 30. The weather-strip 34 is formed of rubber, for example. In a state where the door 3 is closed, the weather-strip 34 is liquid-tightly attached to the frame 20 of the vehicle body 2. The door 3 is connected to the frame 20 of the vehicle body 2 with a plurality of hinges 8 (refer to FIGS. 6 and 7 described hereinafter) so that a passenger door (in other words, entrance/exit door) 26 of the vehicle body 2 can be opened and closed.

The vehicle body 2 includes a vehicle body-side weather-strip 24 for waterproof in addition to the frame 20 and the instrument panel 22. The vehicle body-side weather-strip 24 (also simply referred to as the weather-strip 24) is attached to the frame 20, and is allocated along an opening edge of the passenger door 26 covered by the door 3. The weather-strip 24 is formed of rubber, for example. In a state where the door 3 is closed, the weather-strip 24 is liquid-tightly attached to an outer peripheral edge part of the door 3.

The routing structure 10 includes at least one wire-like transmission member 4 routed between the vehicle body 2 and the door 3 and at least one wire-like transmission member 6 routed between the vehicle body 2 and the door 3, for example. The wire-like transmission member 4 is a wire-like transmission member for a standard-mounted component mounted to the door 3. The wire-like transmission member 4 is directly or indirectly connected to the standard-mounted component to supply a power source or transmit a signal to the standard-mounted component. The wire-like transmission member 6 is a wire-like transmission member for an optional component mounted to the door 3. The wire-like transmission member 6 is directly or indirectly connected to the optional component to supply a power source or transmit a signal to the optional component. One ends of the wire-like transmission members 4 and 6 are located on an inner side of the vehicle body 2, and the other ends of the wire-like transmission members 4 and 6 are located inside the door 3.

Herein, the standard-mounted component is a component previously mounted before shipment of the vehicle 1, and is mounted in manufacturing the vehicle 1. The standard-mounted component includes a so-called factory-installed option. The standard-mounted component mounted to the door 3 includes an electrical component for a power window, an electrical component for door locking, an electrical component for an electronic mirror, and a speaker, for example. For example, when the wire-like transmission member 4 is a member transmitting electricity such as an electrical wire, the wire-like transmission member 4 is electrically connected to the standard-mounted component. In the meanwhile, the optional component is a component mounted after the vehicle 1 is manufactured and shipped out, and is mounted in a dealer, for example. The optional component includes a so-called dealer-installed option. The optional component includes not only an apparatus mounted in addition to the standard-mounted component but also an apparatus mounted in place of the standard-mounted component. The optional component mounted to the door 3 includes a camera, a ranging sensor, and the other sensor, for example. For example, when the wire-like transmission member 6 is a member transmitting electricity such as an electrical wire, the wire-like transmission member 6 is electrically connected to the optional component. Hereinafter, the simple standard-mounted component indicates a standard-mounted component mounted to the door 3, and the simple optional component indicates an optional component mounted to the door 3.

The routing structure 10 includes the plurality of wire-like transmission members 4, for example. The plurality of wire-like transmission members 4 include a plurality of electrical wires for supplying a power source and transmitting a signal to a plurality of standard-mounted components, for example. A bridge part of each wire-like transmission member 4 passing between the vehicle body 2 and the door 3 is covered by an exterior member 5, for example. The exterior member 5 is a grommet, for example. Both ends of the exterior member 5 are connected to the frame 20 of the vehicle body 2 and the panel 30 of the door 3, respectively, and the exterior member 5 passes between the vehicle body 2 and the door 3. For example, the plurality of wire-like transmission members 4 and the exterior member 5 constitute a wire harness in the routing structure 10. The wire harness is also considered a wiring member. The exterior member 5 may be a member other than the grommet.

The wire-like transmission member 6 is provided to the routing structure 10 in accordance with the optional component mounted to the door 3. When the optional component is not mounted to the door 3, differing from the example in FIGS. 1 and 2, the wire-like transmission member 6 is not provided to the routing structure 10.

The wire-like transmission member 6 performs at least one of supply of a power source and/or transmission of a signal on the optional component, for example. A type of the wire-like transmission member 6 is appropriately selected in accordance with the optional component. For example, when the optional component is an Ethernet-compatible apparatus, an Ethernet cable is adopted as the wire-like transmission member 6.

The wire-like transmission member 6 is routed between the instrument panel 22 of the vehicle body 2 and the door trim 32. The wire-like transmission member 6 is inserted into a side surface part 220 of the instrument panel 22, and is inserted into the door trim 32, for example. The routing structure 10 may include the plurality of wire-like transmission members 6.

As illustrated in FIGS. 1 and 2, a part of the wire-like transmission member 4 between the vehicle body 2 and the door 3 (in other words, a part covered by the exterior member 5) is routed closer to the exterior side than the weather-strips 24 and 34. In the similar manner, the exterior member 5 is also routed closer to the exterior side than the weather-strips 24 and 34, for example. In the meanwhile, a part of the wire-like transmission member 6 between the vehicle body 2 and the door 3 is routed closer to the interior side than the weather-strips 24 and 34.

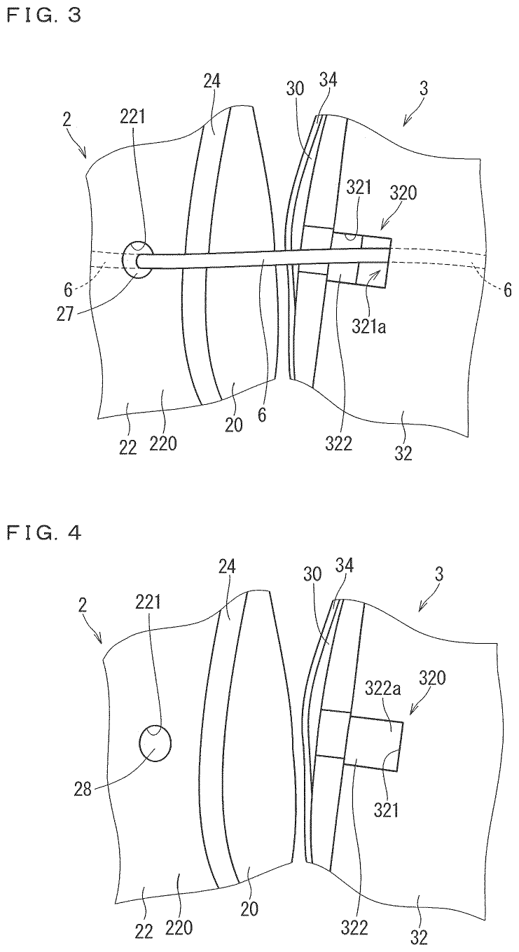

FIGS. 3 and 4 are enlarged schematic view illustrating an example of an area near the position into which the wire-like transmission member 6 is inserted in the instrument panel and 22 the door trim 32. FIG. 3 illustrates an example that the wire-like transmission member 6 is routed in accordance with the mounted optional component. FIG. 4 illustrates an example that the optional component is not mounted and the wire-like transmission member 6 is not routed.

Provided to the side surface part 220 of the instrument panel 22 is an insertion port 221 into which the wire-like transmission member 6 is inserted when the wire-like transmission member 6 is mounted to the vehicle 1. The through port 221 is a through hole passing through the side surface part 220 in a thickness direction thereof. In shipping out the vehicle 1, the insertion port 221 is covered by a cover member 28, for example, as illustrated in FIG. 4. When the optional component is mounted after the vehicle 1 is shipped out, the cover member 28 is detached, and the wire-like transmission member 6 is inserted into the exposed insertion port 221. Then, a gap between the wire-like transmission member 6 and the insertion port 221 is filled with a filling material 27, for example (refer to FIG. 3).

In shipping out the vehicle 1, the door trim 32 includes a scheduled insertion region 320 where the wire-like transmission member 6 is to be inserted when the wire-like transmission member 6 is mounted to the vehicle 1 (refer to FIG. 4). The scheduled insertion region 320 is also considered a reserved region for inserting the wire-like transmission member 6 afterward. The scheduled insertion region 320 is also considered an ensured region ensured for inserting the wire-like transmission member 6 afterward.

The scheduled insertion region 320 includes an insertion port 321 into which the wire-like transmission member 6 is inserted and a cover member 322 covering the insertion port 321, for example. The cover member 322 can be attached to and detached from the body of the door trim 32, for example. In shipping out the vehicle 1, the whole region of the insertion port 321 is covered by the cover member 322 (refer to FIG. 4). When the optional component is mounted after the vehicle 1 is shipped out, a part 322a of the cover member 322 is removed, and the insertion port 321 is partially exposed. Then, the wire-like transmission member 6 is inserted into an exposed part 321a of the insertion port 321 (refer to FIG. 3). The part 322a of the cover member 322 may be removed by folding an end portion of the cover member 322, for example.

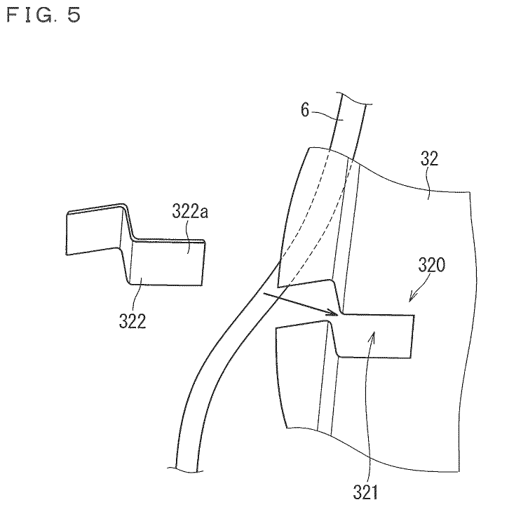

FIG. 5 is a schematic diagram, illustrating an example that the cover member 322 is detached from the body of the door trim 32. The insertion port 231 is a notched part reaching the edge of the door trim 32, for example. As illustrated in FIG. 5, an operator inserts the wire-like transmission member 6 into the insertion port 321 from a side of the edge of the door trim 32, for example. Then, the cover member 322 from which the part 322a is removed is attached to the body of the door trim 32, thus as illustrated in FIG. 3, the wire-like transmission member 6 is inserted into the exposed part 321a of the insertion port 321. In the state where the door 3 is closed, the insertion port 321 faces the insertion port 221 of the instrument panel 22. Specifically, in the state where the door 3 is closed, the exposed part 321a of the insertion port 321 faces the insertion port 221 of the instrument panel 22. Accordingly, a length of a bridge part of the wire-like transmission member 6 in the state where the door 3 is closed can be reduced. In the state where the door 3 is closed, the exposed part 321a of the insertion port 321, the insertion port 221, and the bridge part of the wire-like transmission member 6 are hardly seen from the interior side.

When the wire-like transmission member 6 is mounted, the cover member 322 may not be attached to the body of the door trim 32. The scheduled insertion region 320 may include only the insertion port 321, and may not previously include the cover member 322. In the manner similar to the insertion port 221, the insertion port 221 provided to the instrument panel 22 may be a notched part. In this case, the wire-like transmission member 4 can be easily inserted into the insertion port 221. The insertion port 321 of the door trim 32 may not be the notched part.

In this manner, in the present example, the door trim 32 includes the scheduled insertion region 320 where the wire-like transmission member 6 for the optional component is to be inserted, thus the wire-like transmission member 6 for the optional component can be routed independently from the wire-like transmission member 4 for the standard-mounted component. Accordingly, operability of routing the wire-like transmission member 6 for the optional component is improved. For example, the wire-like transmission member 6 needs not necessarily be routed in the exterior member 5 together with the wire-like transmission member 4 for the standard-mounted component, thus a space for routing the wire-like transmission member 6 can be easily ensured. The scheduled insertion region 320 is provided to the door trim 32, thus a user routes the wire-like transmission member 6 closer to the interior side than the wire-like transmission member 4. Thus, a space for an operation of routing the wire-like transmission member 6 can be easily ensured. When the plurality of wire-like transmission members 6 are provided, some of the plurality of wire-like transmission members 6 may be passed through the exterior member 5.

In the present example, the scheduled insertion region 320 includes the insertion port 321 into which the wire-like transmission member 6 is inserted and the cover member 322 covering the insertion port 321. Accordingly, the wire-like transmission member 6 for the optional component can be inserted into the preset insertion port 321, thus the wire-like transmission member 6 can be easily routed.

In the present example, the insertion port 321 is the notched part reaching the edge of the door trim 32, thus the wire-like transmission member 6 can be inserted into the insertion port 321 from the side of the edge of the door trim 32. Accordingly, the wire-like transmission member 6 can be easily inserted into the insertion port 321, and operability of routing the wire-like transmission member 6 is improved.

The scheduled insertion region 320 is located closer to the interior side than the door-side weather-strip 34, thus water is hardly splashed on the wire-like transmission member 6 for the optional component inserted into the scheduled insertion region 320.

In the present example, the wire-like transmission member 6 is inserted into the side surface part 220 of the instrument panel 22, thus can be hardly seen when the door 3 is closed.

In the present example, differing from the wire-like transmission member 4 for the standard-mounted component, the wire-like transmission member 6 for the optional component is routed closer to the interior side than the door-side weather strip 34 and the vehicle body-side weather strip 24, thus the space for the operation of routing the wire-like transmission member 6 for the optional component can be easily ensured.

FIGS. 6 and 7 are schematic views illustrating an example of the door 3 from which the door trim 32 is detached. FIG. 6 illustrates an example of the closed door 3, and FIG. 7 illustrates an example of the opened door 3. FIGS. 6 and 7 illustrate the plurality of hinges 8 for openably and closably connecting the door 3 to the frame 20. FIGS. 6 and 7 also illustrate an example that the exterior member 5 is connected to the panel 30 of the door 3.

As can be understood by comparing FIGS. 1 and 2 described above, in the state where the door 3 is closed, a distance from the door trim 32 to the side surface part 220 of the instrument panel 22 gets smaller. Thus, in the present example, a redundant length of the wire-like transmission member 6 occurs in the door 3 in accordance with the close operation of the door 3. The door 3 according to the present example includes an arrangement space 700 in which the redundancy absorption part 7 absorbing the redundant length of the wire-like transmission member 6 occurring in accordance with the close operation of the door 3 is disposed between the door trim 32 and the panel 30. Accordingly, the redundancy absorption part 7 disposed in the arrangement space 700 can absorb the redundant length of the wire-like transmission member 6 for the optional component occurring in accordance with the close operation of the door 3. The arrangement space 700 is previously provided to the door 3 in manufacturing the vehicle 1. The arrangement space 700 is also considered a region previously ensured in the door 3 in manufacturing the vehicle 1.

The redundancy absorption part 7 may be disposed in the arrangement space 700 in accordance with the mounted wire-like transmission member 6. That is to say, it is also applicable that the redundancy absorption part 7 is not provided to the arrangement space 700 when the vehicle 1 is shipped out, but is disposed in the arrangement space 700 in accordance with the wire-like transmission member 6 mounted after the vehicle 1 is shipped out. Alternatively, the redundancy absorption part 7 may be disposed in the arrangement space 700 regardless of whether or not the wire-like transmission member 6 is mounted. That is to say, the redundancy absorption part 7 may be disposed in the arrangement space 700 in manufacturing the vehicle 1. In this case, the door 3 includes the redundancy absorption part 7 disposed in the arrangement space 700 in shipping out the vehicle 1. The redundancy absorption part 7 is provided, thus the redundant length of the wire-like transmission member 6 occurring in accordance with the close operation of the door 3 hardly interfere with opening and closing of the door 3.

The redundancy absorption part 7 can wind and house the wire-like transmission member 6, for example. FIGS. 6 and 7 illustrates an example of an inner part of the redundancy absorption part 7. The redundancy absorption part 7 may be attached to the panel 30, or may also be attached to the door trim 32.

The redundancy absorption part 7 includes a winding shaft part 75 around which the wire-like transmission member 6 is wound and a housing part 76 housing a winding part 60 around the winding shaft part 75 in the wire-like transmission member 6, for example. The housing part 76 is formed into a box-like shape with a housing space in which the wire-like transmission member 6 is wound and housed. The winding shaft part 75 is provided in the housing part 76. The winding shaft part 75 has a columnar shape, and is also considered a protrusion part, for example. The winding shaft part 75 protrudes along a thickness direction of the door 3, for example. For example, the wire-like transmission member 6 is wound for one round around the winding shaft part 75. A diameter of the winding part 60 of the wire-like transmission member 6 is changed in accordance with opening and closing of the door 3 in the housing part 76.

The redundancy absorption part 7 includes an entrance-side guide part 77 guiding the wire-like transmission member 6 inserted into the insertion port 321 of the door trim 32 into the housing part 76. The redundancy absorption part 7 includes an exit-side guide part 78 guiding the wire-like transmission member 6 located in the housing part 76 to an outer side of the redundancy absorption part 7. The entrance-side guide part 77 and the exit-side guide part 78 are formed into a cylindrical shape, for example. An inner space of the entrance-side guide part 77 and an inner space of the housing part 76 (in other words, a housing space for the winding part 60) are connected to each other. An inner space of the exit-side guide part 78 and an inner space of the housing part 76 are connected to each other. The wire-like transmission member 6 guided into the housing part 76 from the entrance-side guide part 77 is wound for one round around the winding shaft part 75, and then led to the outer side of the redundancy absorption part 7 from the exit-side guide part 78.

In the redundancy absorption part 7 having the above configuration, the wire-like transmission member 6 in the housing part 76 is led from the entrance-side guide part 77 in accordance with the open operation of the door 3, and the diameter of the winding part 60 in the housing part 76 decreases as illustrated in FIG. 7. In the meanwhile, the bridge part of the wire-like transmission member 6 between the door 3 and the vehicle body 2 is led into the housing part 76 from the entrance-side guide part 77 in accordance with the close operation of the door 3, and the diameter of the winding part 60 in the housing part 76 increases as illustrated in FIG. 6. In the state where the door 3 is completely closed, the diameter of the winding part 60 gets largest, and in the state where the door 3 is maximally opened, the diameter of the winding part 60 gets smallest.

In this manner, the redundancy absorption part 7 can absorb the redundant length of the wire-like transmission member 6 with a simple configuration that the diameter of the winding part 60 around the winding shaft part 75 in the wire-like transmission member 6 is changed in accordance with opening and closing of the door 3.

In the present example, the redundancy absorption part absorbing the redundant length of the wire-like transmission member 4 is not particularly provided. In the present example, a height difference is provided to routing in the bridge part between the vehicle body 2 and the door 3 in the wire-like transmission member 4, for example. The bridge part of the wire-like transmission member 4 can be twisted around an axis along a height direction (in other words, the up-down direction) of the vehicle 1 in accordance with the close operation of the door 3, thus the redundant length of the wire-like transmission member 4 can be absorbed.

It is also applicable that in the manner similar to the wire-like transmission member 4, the height difference is provided to routing in the bridge part between the vehicle body 2 and the door 3 in the wire-like transmission member 6, thus the bridge part can be twisted around the axis along the height direction of the vehicle 1 in accordance with the close operation of the door 3. In this case, the redundancy absorption part 7 may not be mounted to the door 3. The redundancy absorption part absorbing the redundant length of the wire-like transmission member 4 may be mounted to the door 3.

In the state where the door 3 is opened as illustrated in FIG. 2 described above, water may adhere to the bridge part between the door 3 and the vehicle body 2 in the wire-like transmission member 6. Thus, in the present example, as illustrated in FIGS. 1, 2, 6, and 7, the door 3 includes a removal part 9 removing water adhering to a part of the wire-like transmission member 6 between the scheduled insertion region 320 and the redundancy absorption part 7. The removal part 9 is located near the insertion port 321 of the door trim 32 between the door trim 32 and the panel 30, for example. The removal part 9 is a brush, for example. A larger number of bristles in the removal part 9 have contact with a part of the wire-like transmission member 6 between the scheduled insertion region 320 of the door trim 32 and the redundancy absorption part 7. The removal part 9 is disposed so that the wire-like transmission member 6 passes between the large number of bristles in the removal part 9.

In accordance with the function of the removal part 9, water on a part of the wire-like transmission member 6 led into the door 3 in the close operation of the door 3 can be removed. Thus, water is hardly splashed on an apparatus in the door 3 such as a standard-mounted component or the optional component, for example.

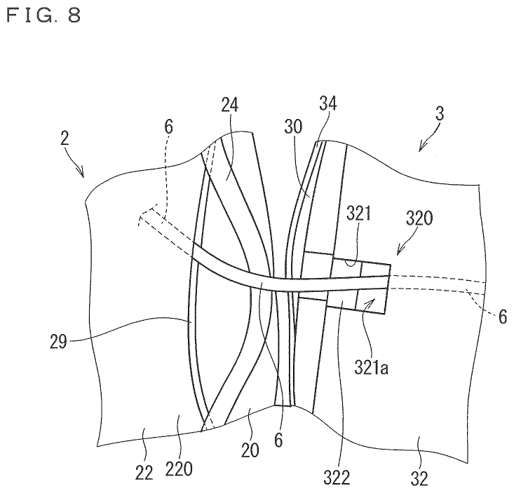

The configurations of the routing structure 10 and the door 3 are not limited to the above example. For example, the wire-like transmission member 6 may be inserted into a part of the instrument panel 22 other than the side surface part 220. For example, the wire-like transmission member 6 may be inserted into a loser surface part (in other words, the bottom part) of the instrument panel 22. The wire-like transmission member 6 may be routed between the frame 20 of the vehicle body 2 and the side surface part 220 of the instrument panel 22. FIG. 8 is a schematic views illustrating an example of such a state. FIG. 8 illustrates an example that the vehicle body-side weather-strip 24 is partially detached from the frame 20 for convenience of description.

In the example in FIG. 8, a gap 29 is located between the side surface part 220 of the instrument panel 22 and the frame 20. The wire-like transmission member 6 is taken out from the gap 29 to an outer side of the vehicle body 2, and is inserted into the insertion port 321 of the door trim 32. After the wire-like transmission member 6 is taken out from the gap 29, the whole region of the gap 29 is covered by the weather-strip 24.

In this manner, when the wire-like transmission member 6 is routed between the frame 20 and the side surface part 220 of the instrument panel 22, the wire-like transmission member 6 can be hardly seen in the case where the door 3 is closed in the manner similar to the case where the wire-like transmission member 6 is inserted into the side surface part 220 of the instrument panel 22.

It is also applicable that a thin film is formed in the insertion port 321 of the scheduled insertion region 320 in manufacturing the vehicle 1, and at least a part of the thin film is ripped after shipping out the vehicle 1 to insert the wire-like transmission member 6 into the insertion port 321. In the similar manner, it is also applicable that a thin film is formed in the insertion port 221 of the instrument panel 22 in manufacturing the vehicle 1, and at least a part of the thin film is ripped after shipping out the vehicle 1 to insert the wire-like transmission member 6 into the insertion port 221.

Although the door trim, the vehicle door, and the routing structure are described above in detail, the foregoing description is in all aspects illustrative and does not restrict the disclosure. The various modification examples described above can be appropriately combined and applied as long as they are not contradictory. It is therefore understood that numerous modification examples can be devised without departing from the scope of the invention.

### EXPLANATION OF REFERENCE SIGNS

1 vehicle
2 vehicle body
3 vehicle door
4 wire-like transmission member
5 exterior member
6 wire-like transmission member
7 redundancy absorption part
8 hinge
9 removal part
10 routing structure
20 frame
22 instrument panel
24 vehicle body-side weather-strip
26 passenger door
27 filling material
28, 322 cover member
29 gap
30 panel
32 door trim
34 door-side weather-strip
60 winding part
75 winding shaft part
76 housing part
77 entrance-side guide part
78 exit-side guide part
220 side surface part
221, 321 insertion port
320 scheduled insertion region
321a exposed part
322a part
700 arrangement space

1. A door trim constituting a design on an interior side of a vehicle door, comprising
a scheduled insertion region where a wire-like transmission member for an optional component mounted to the vehicle door is to be inserted.

2. The door trim according to claim 1, wherein
the scheduled insertion region includes:
an insertion port into which the wire-like transmission member is inserted; and
a cover member covering the insertion port.

3. The door trim according to claim 2, wherein
the insertion port is a notched part reaching an edge of the door trim.

4. A vehicle door, comprising:
the door trim according to claim 1;
a panel to which the door trim is attached; and
a door-side weather-strip provided to the panel, wherein
the scheduled insertion region is located closer to an interior side than the door-side weather-strip.

5. The vehicle door according to claim 4, wherein
an arrangement space where a redundancy absorption part absorbing a redundant length of the wire-like transmission member occurring in accordance with a close operation of the vehicle door is provided between the door trim and the panel.

6. The vehicle door according to claim 5, comprising
the redundancy absorption part disposed in the arrangement space.

7. The vehicle door according to claim 6, wherein
the redundancy absorption part includes:
a winding shaft part around which the wire-like transmission member is wound; and
a housing part housing a winding part around the winding shaft part in the wire-like transmission member, wherein
a diameter of the winding part is changed in accordance with opening and closing of the vehicle door in the housing part.

8. The vehicle door according to claim 6, comprising
a removal part removing water adhering to a part of the wire-like transmission member between the scheduled insertion region and the redundancy absorption part.

9. A routing structure, comprising:
a first wire-like transmission member for an optional component mounted to the vehicle door to be routed between the vehicle door according to claim 4 and a vehicle body to which the vehicle door is openably and closably attached and inserted into the scheduled insertion region of the door trim of the vehicle door; and
a second wire-like transmission member for a standard-mounted component mounted to the vehicle door to be routed between the vehicle door and the vehicle body, wherein
the vehicle door includes a door-side weather-strip provided to the panel,
the vehicle body includes a vehicle body-side weather-strip,
a part of the first wire-like transmission member between the vehicle door and the vehicle body is routed closer to an interior side than the door-side weather-strip and the vehicle body-side weather-strip, and
a part of the second wire-like transmission member between the vehicle door and the vehicle body is routed closer to an exterior side than the door-side weather-strip and the vehicle body-side weather-strip.

10. The routing structure according to claim 9, wherein
the first wire-like transmission member is inserted into a side surface part of an instrument panel of the vehicle body or routed between a frame of the vehicle body and the side surface part.
